(19) United States
(12) Patent Application Publication
(10) Pub. No.: US 2024/0104302 A1
(43) Pub. Date: Mar. 28, 2024

(54) MINUTES PROCESSING METHOD AND APPARATUS, DEVICE, AND STORAGE MEDIUM

(71) Applicant: Beijing Zitiao Network Technology Co., Ltd., Beijing (CN)

(72) Inventors: Xiang ZHENG, Beijing (CN); Jingsheng YANG, Beijing (CN); Cheng QIAN, Beijing (CN); Mengyuan XIONG, Beijing (CN); Kojung CHEN, Beijing (CN); Huiling ZHUANG, Beijing (CN)

(21) Appl. No.: 18/276,208

(22) PCT Filed: Feb. 7, 2022
(86) PCT No.: PCT/CN2022/075396

§ 371 Date: Aug. 7, 2023

(30) Foreign Application Priority Data
Feb. 8, 2021 (CN) 202110180583.0

(51) Int. Cl. G06F 40/279

(52) U.S. Cl. CPC G06F 40/279

(57) ABSTRACT

The embodiment of the present disclosure relates to a minutes processing method and apparatus, a device, and a storage medium, and the method includes: obtaining a to-be-processed text; performing minutes extraction on the to-be-processed text based on a predetermined minutes categories, and determining a minutes sentence belonging to each predetermined minutes categories; determining another sentence associated with the minutes sentence from the to-be-processed text, and storing an association relationship between each minutes sentence and the corresponding another sentence. Through the technical aspect, it is achieved that the minutes of the to-be-processed text is extracted from multiple dimensions, and compatibility of the minutes to various text forms, minutes information content and query efficiency of the to-be-processed text are improved.

### CROSS-REFERENCE TO RELATED APPLICATION

The present application claims priority to Chinese patent Application No. 202110180583.0, filed on Feb. 8, 2021, and titled “MINUTES PROCESSING METHOD AND APPARATUS, DEVICE, AND STORAGE MEDIUM”, all contents of which are combined in the present disclosure through reference.

### TECHNICAL FIELD

The present disclosure relates to the technical field of computers, and more particularly, to a minutes processing method and apparatus, a device, and a storage medium.

### BACKGROUND

Minutes is a very important text information summary and extraction mode. When minutes extraction is carried out, it is required that a text content is summarized as much as possible, and a length is as short as possible. Based on this, a current mainstream minutes extraction mode is to extract based on the content. When it is applied to a conference scene, it means preforming minutes extraction based on content information of a conference text, to obtain conference minutes. The conference minutes can help conference related personnel to quickly understand or review the conference content. However, conference information amount included in the conference minutes obtained by the content-based conference minutes extraction mode is limited.

### SUMMARY

In order to solve the technical problem or at least partially solve the technical problem, the present disclosure provides a minutes processing method and apparatus, a device, and a storage medium.

An embodiment of the present disclosure provides a minutes processing method, including: obtaining a to-be-processed text; performing minutes extraction on the to-be-processed text based on predetermined minutes categories to determine a minutes sentence belonging to each of the predetermined minutes categories; and determining another sentence associated with the minutes sentence from the to-be-processed text, and storing an association relationship between the minutes sentence and the other sentence.

An embodiment of the present disclosure further provides a minutes processing method, including: obtaining a minutes sentence corresponding to each of predetermined minutes categories in a to-be-processed text, the minutes sentences being obtained by performing minutes extraction on the to-be-processed text based on the predetermined minutes categories; displaying the predetermined minutes category and the minutes sentences corresponding to the predetermined minutes category; and displaying, in response to detecting an association display instruction, another sentence in the to-be-processed text associated with a target minutes sentence corresponding to the association display instruction based on the target minutes sentence and an association relationship between the target minutes sentence and the other sentence.

An embodiment of the present disclosure provides a minutes processing apparatus, including: a text obtaining module, configured to obtain a to-be-processed text; a minutes sentence determination module, configured to perform minutes extraction on the to-be-processed text based on predetermined minutes categories to determine a minutes sentence corresponding to each of the predetermined minutes categories; and an association relationship storage module, configured to determine another sentence associated with the minutes sentence from the to-be-processed text, and store an association relationship between the minutes sentence and the corresponding other sentence.

An embodiment of the present disclosure provides a minutes processing apparatus, including: a minutes sentence obtaining module, configured to obtain a minutes sentence corresponding to each of predetermined minutes categories in a to-be-processed text, the minutes sentence being obtained by performing minutes extraction on the to-be-processed text based on the predetermined minutes categories; a minutes sentence display module, configured to display the predetermined minutes category and the minutes sentence corresponding to the predetermined minutes category; and an other sentence display module, configured to display, in response to detecting an association display instruction, another sentence in the to-be-processed text associated with a target minutes sentence corresponding to the association display instruction based on the target minutes sentence and an association relationship between the target minutes sentence and the other sentence.

An embodiment of the present disclosure provides an electronic device, and the electronic device includes: a processor; and a memory having an executable instruction of the processor stored thereon, wherein the processor is configured to read the executable instruction from the memory and execute the instruction to implement the minutes processing method of the embodiment of the present disclosure.

An embodiment of the present disclosure provides a computer readable storage medium, the storage medium stores a computer program, and the computer program is configured to execute the minutes processing method of the embodiment of the present disclosure.

In the minutes processing solution provided by the embodiment of the present disclosure, the minutes extraction can be performed on the to-be-processed text according to the predetermined minutes categories, and the minutes sentence corresponding to each of the predetermined minutes categories are respectively obtained, which achieves extraction of minutes of the to-be-processed text from multiple dimensions and improves compatibility of the minutes to various text forms and an information content of the minutes. Moreover, the other sentence remaining in the to-be-processed text can be associated with the minutes sentences, so that other text contents associated with the minutes sentences are quickly obtained from the minutes sentence, and the query efficiency of the to-be-processed text is improved.

### BRIEF DESCRIPTION OF DRAWINGS

The accompanying drawings, which are incorporated in and constitute a part of the description, illustrate embodiments consistent with the present disclosure and used to explain the principles of the present disclosure together with the description.

In order to illustrate the technical solutions in the embodiments of the present disclosure or the related art more clearly, the drawings that need to be used in the description of the embodiments or the related art are briefly described below. Obviously, a person of ordinary skill in the art can obtain other drawings according to these drawings without involving any inventive effort.

FIG. 1 is a schematic flowchart of a minutes processing method provided by an embodiment of the present disclosure;

FIG. 2 is a schematic flowchart of another minutes processing method according to an embodiment of the present disclosure;

FIG. 3 is a schematic flowchart of another minutes processing method according to an embodiment of the present disclosure;

FIG. 4 is a structural schematic diagram of a minutes processing apparatus provided by an embodiment of the present disclosure;

FIG. 5 is a structural schematic diagram of another minutes processing apparatus according to an embodiment of the present disclosure;

FIG. 6 is a structural schematic diagram of an electronic device according to an embodiment of the present disclosure.

### DESCRIPTION OF EMBODIMENTS

In order to understand the above embodiments, features and advantages of the present disclosure more clearly, the aspects of the present disclosure are further described below. It should be noted that, in the case of no conflict, the embodiments of the present disclosure and the features in the embodiments may be combined with each other.

Numerous exemplary details are set forth in the following description to facilitate a sufficient understanding of the present disclosure, but the present disclosure may also be practiced otherwise than as described herein; obviously, the embodiments in the specification are only a part of the embodiments of the present disclosure rather than all the embodiments.

The minutes processing method provided by an embodiment of the present disclosure is mainly suitable for scenes of generating minutes for various texts, for example, suitable for generating conference minutes for various conferences. The minutes processing method provided by the embodiment of the present disclosure can be executed by a minutes processing apparatus, the apparatus can be realized by software and/or hardware, and the apparatus can be integrated in an electronic device having a text processing function, such as a mobile phone, a palm computer, a tablet computer, a notebook computer, a desktop computer or a server and the like.

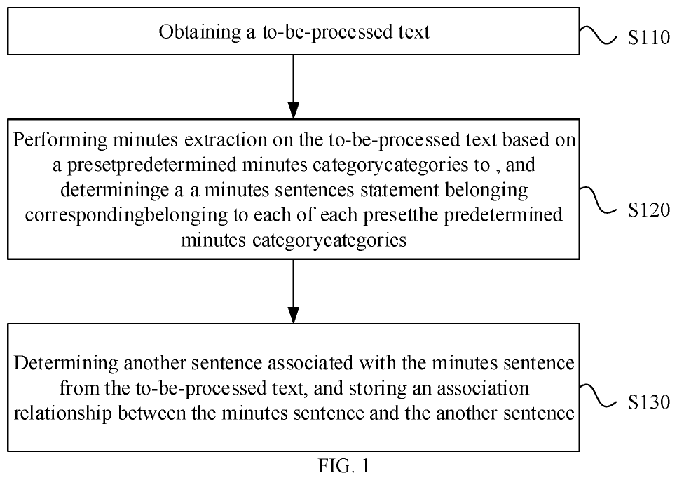

FIG. 1 is a flowchart of a minutes processing method according to an embodiment of the present disclosure. Referring to FIG. 1, the minutes processing method exemplary includes: S110, a to-be-processed text is obtained.

The to-be-processed text refers to a text needing text minutes extraction, and it can be an article, webpage content, a subtitle text (namely, a conference text) of a conference and the like. In the embodiment of the present disclosure, a case, in which the to-be-processed text is a conference text, is taken as an example for description, so that the minutes is conference minutes.

A subtitle text of a conference, namely a conference text, is obtained. In some embodiments, the conference text may be obtained by converting conference voice recorded during a conference. In some embodiments, the conference text may be obtained by manual recording. In some embodiments, the conference text with higher accuracy can be obtained by combining the conference text obtained by voice conversion and the conference text obtained by manual recording.

S120, minutes extraction on the to-be-processed text based on predetermined minutes categories is performed to determine a minutes sentence belonging to each of the predetermined minutes categories.

The predetermined minutes categories are a predetermined text categories which correspond to different dimensions of the conference text. The predetermined minutes categories may be determined according to service requirements. In some embodiments, the predetermined minutes categories includes at least one of a task planning category, a text conclusion category, and a text topic category. The task planning category corresponds to text content such as next task arrangement. The text conclusion category and the text topic type respectively correspond to a conference conclusion category and a conference topic category in a conference scene. The conference conclusion category corresponds to the text category such as a summary of the conference content, or a solution for a question discussed by a given conference. The conference topic category corresponds to text content of various conference topics. In the embodiment, the predetermined minutes categories can be any one, any two or three of the task planning category, the text conclusion category and the text topic category.

In the related art, the conference minutes is generated from a content level of a whole conference text, and it is only an integral summary of the conference content. However, this conference minutes generation mode ignores characteristics of more conference participants, more conference subjects, diversity of conference forms and the like, so that the generated conference minutes has insufficient information amount and cannot comprehensively reflect the conference content, and a user cannot quickly obtain required information according to the conference minutes. For example, if a conference text corresponding to a certain conference speaker occupies a relatively small portion in the whole conference text and also has relatively less correlation with the whole conference text, then the conference minutes obtained by the content-based conference minutes extraction mode may not contain the conference content of this speaker or only performs a very simple summary. If someone is interested in the conference content of this speaker after the conference, required information cannot be obtained in the conference minutes, or only extremely few information can be obtained. In this case, only the complete conference text can be checked, so that query efficiency of the conference content is low.

Based on the condition above, in an embodiment of the present disclosure, the minutes sentence is extracted from multiple dimensions, that is, the minutes sentence in the conference text is extracted according to the predetermined minutes categories, and the conference minutes is formed by each predetermined minutes categories and the minutes sentence corresponding thereto, so that the conference minutes contains more comprehensive and diversified conference content.

Exemplarily, the minutes sentence of the corresponding predetermined minutes categories can be extracted through characteristics of the to-be-processed text corresponding to different predetermined minutes categories. In some embodiments, extraction of the minutes sentence of different predetermined minutes categories can be realized by using a machine learning model. In other embodiments, text information related to the minutes sentences of different predetermined minutes categories can be predetermined, and then the minutes sentence is extracted based on a text matching mode.

S130, another sentence associated with the minutes sentence from the to-be-processed text is determined, and an association relationship between the minutes sentence and the other sentence is stored.

The other sentence refers to a sentence in the to-be-processed text except the minutes sentence. The association relationship refers to a corresponding relationship between the minutes sentence and the other sentence. The association relationship is configured to subsequent display or analysis of the minutes and the to-be-processed text, for example, for displaying the other sentence associated with the minutes, in order to improve the efficiency of querying the to-be-processed text by the user.

In the related technology, if the user is interested in the conference content of a certain minutes sentence, more detailed conference content needs to be deeply understood, and only the complete conference text can be checked, but this way consumes time and labor and is very low in efficiency. In order to improve the query efficiency of the conference text, in the embodiment of the present disclosure, the association relationship between each minutes sentence and the other sentence in the conference text is established on a level of the content subject. For example, similarity between the minutes sentence and the other sentence can be calculated through text similarity, and a similarity threshold is set to determine an associated sentence. For another example, a machine learning model is established to screen the other sentence associated with each minutes sentence, etc. Moreover, in order to improve subsequent use convenience, the association relationship between the minutes sentence and the other sentence associated therewith can be stored, for user access viewing.

The minutes processing solution provided by the embodiment of the present disclosure can perform minutes extraction on the to-be-processed text according to the predetermined minutes categories and respectively obtain the minutes sentence corresponding to each predetermined minutes categories, achieving extraction of the text minutes from multiple dimensions, and improving compatibility of the minutes to various text forms and the information content of the minutes. Moreover, it can associate another sentences remaining in the to-be-processed text with the minutes sentences, so that other text contents associated with the minutes sentence are quickly obtained from the minutes sentence, and the query efficiency of the to-be-processed text is improved.

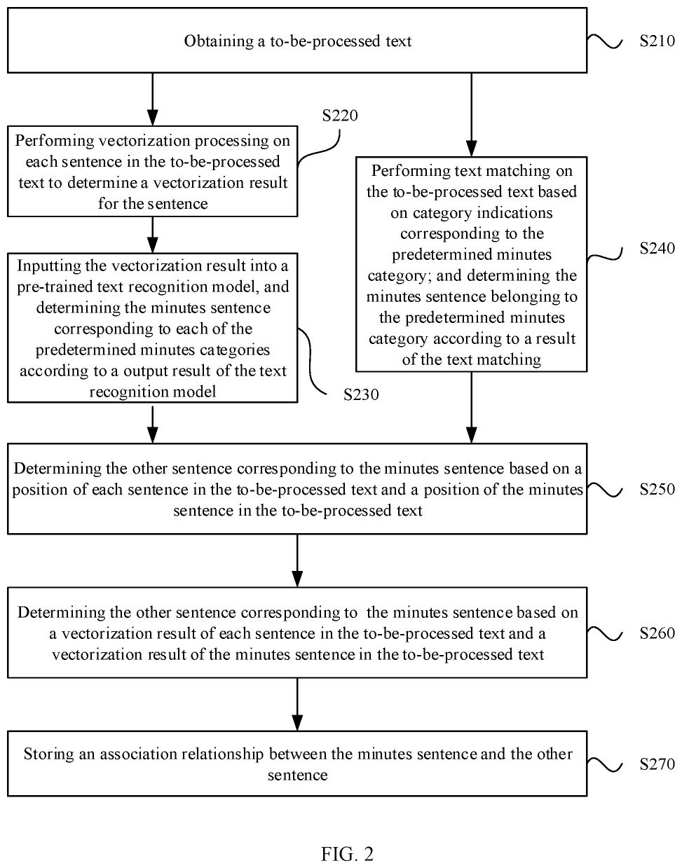

FIG. 2 is a flowchart of another minutes processing method according to an embodiment of the present disclosure. The step “performing minutes extraction on the to-be-processed text based on predetermined minutes categories to determine a minutes sentence belonging to each of the predetermined minutes categories” is further optimized. Based on this, the “determining another sentence associated with the minutes sentence from the to-be-processed text” is further optimized. The explanation of the same or corresponding term as that in the various embodiments above is not repeated herein. Referring to FIG. 2, the minutes processing method includes the following blocks.

S210, a to-be-processed text is obtained.

S220, vectorization processing on each sentence in the to-be-processed text is performed, to determine a vectorization result of the corresponding sentence.

In order to improve the accuracy of minutes sentence extraction, the embodiment of the present disclosure adopts the machine learning model (i.e., a text recognition model) to realize extraction of the minutes sentence, whereas input data of the text recognition model is a digital representation of the sentence, namely, the vectorization result. Exemplarily, firstly, sentence segmentation and filtering (such as elimination of phrase sentences) are carried out on the conference text, to obtain a plurality of sentences corresponding to the conference text. Then, the vectorization processing is performed on each sentence by using a method such as a Word2vec model, to obtain the vectorization result of each sentence.

S230, the vectorization result into a pre-trained text recognition model is inputted, and the minutes sentence corresponding to each of the predetermined minutes categories is determined according to a output result of the text recognition model.

The text recognition model is configured to recognize whether the sentence belongs to one of the predetermined minutes categories. The output of the text recognition model can judge whether an input sentence belongs to one of the predetermined minutes categories. In some embodiments, the text recognition model is a machine learning model; and a training sample of the machine learning model is a plurality of sentences containing a category indication. In the embodiment, the text recognition model is a machine learning model, for example, it can be a deep learning model. Before S230, it is necessary to collect a training sample and train the machine learning model, to obtain the text recognition model. The training sample contains a plurality of sentences belonging to each predetermined minutes categories. For example, sentences containing the category indications corresponding to each predetermined minutes categories are collected. The collection sources of these sentences are preferably various conference texts. However, in order to perfect the training sample and improve the accuracy of the model, required sentences can also be collected from other sources such as articles, news and webpages.

The vectorization result of the sentence obtained in S220 is respectively input into a trained text recognition model, and a corresponding model output result is obtained after model operation. The model output result represents whether the input vectorization result belongs to a certain predetermined minutes categories. For example, the model output result indicates that the input vectorization result belongs to the task planning category, then the sentence corresponding to the vectorization result is determined as the minutes sentence under the task planning category. If the model output result indicates that the input vectorization result does not belong to any predetermined minutes categories, then the sentence corresponding to the vectorization result is eliminated.

S240, text matching on the to-be-processed text based on category indications corresponding to the predetermined minutes categories is performed; and the minutes sentence belonging to the predetermined minutes categories according to a result of the text matching is determined.

By representing a feature word (i.e., a category indication) of each predetermined minutes categories, text matching is performed on the conference text to extract the minutes sentence. The category indication herein may be, for example, a word indicating task arrangement such as “next step”, “plan”, “arrangement” and the like in the task planning category, a word indicating a conclusion or a determination such as “so”, “in summary”, “in conclusion”, “overall” and the like in the conference conclusion category, a word drawing a conference issue such as “issue”, “discussion” and the like in the conference topic category. During exemplary implementation, the category indication corresponding to each predetermined minutes categories can be subjected to text similarity calculation with effective words (non-modal auxiliary words, stop words and the like) contained in each sentence in the conference text. When the text similarity reaches a certain threshold, it can be determined that the sentence corresponding to the text similarity belongs to the predetermined minutes categories corresponding to the category indication participating in the text similarity calculation, and the sentence is the minutes sentence under this category. In this way, the minutes sentences under different minutes categories can be extracted with simpler logic, and convenience of conference minutes generation is improved.

It should be noted that one of S220-S230 and S240 is selected to be executed, for example, S210, S240 and S250-S270 can be executed, and S210-S230 and S250-S270 can also be executed.

S250, the other sentence corresponding to the minutes sentence is determined based on a position of each sentence in the to-be-processed text and a position of the minutes sentence in the to-be-processed text.

The closer the positions of a certain another sentence and the minutes sentence in the conference text are, the greater the possibility that the other sentence is associated with the minutes sentence on the content level, then the other sentence can be determined as a sentence associated with the minutes sentence. Therefore, according to the position (a full-text position or a paragraph position) of each sentence of the conference text in the conference text and a distance between this position and the position of the minutes sentence in the conference text, the other sentence associated with each minutes sentence can be determined.

S260, the other sentence corresponding to the minutes sentence is determined based on a vectorization result of each sentence in the to-be-processed text and a vectorization result of the minutes sentence in the to-be-processed text.

The higher the text similarity between a certain another sentence and the minutes sentence is, the greater the possibility that the other sentence is associated with the minutes sentence on the content level, then the other sentence can be determined as the sentence associated with the minutes sentence. Therefore, the text similarity can be calculated by using the vectorization result of each sentence in the conference text and the vectorization result of the minutes sentence, and the other sentence associated with the minutes sentence is determined according to the text similarity.

It should be noted that one of S250 and S260 can be selected to be executed, or all of them may be executed. When both S250 and S260 are executed, an execution order of the two is not limited. In an embodiment where both S250 and S260 are executed, an integrated mode between two indexes of position similarity degree and text similarity can be set, such as multiplication or weighted summation, and a filtering rule of an integrated value is set, for example, a filtering threshold is set, and the other sentence meeting the filtering threshold can be determined as an associated sentence. Two indexes can also be not integrated, but a filtering rule is set for a single index. In this way, the accuracy of the association relationship between the other sentence and the minutes sentence can be further improved.

S270, an association relationship between the minutes sentence and the other sentence is stored.

The minutes processing solution provided by the embodiment of the present disclosure, through performing vectorization processing on each sentence in the to-be-processed text, determines a vectorization result of the corresponding sentence; inputs each vectorization result into a pre-trained text recognition model, and determines the minutes sentence belonging to each predetermined minutes categories according to a model output result. It is achieved that the minutes sentence in the to-be-processed text is identified based on the machine learning model, and the accuracy and comprehensiveness of minutes sentence extraction are improved, further enriching the information amount of the minutes. By determining the other sentence associated with the minutes sentence from the to-be-processed text and storing the association relationship between each minutes sentence and the corresponding another sentence, the association between the other sentence in the to-be-processed text and the minutes sentence is realized, and the content of the to-be-processed text is further sorted, thereby providing a basis for efficient query and display of subsequent content.

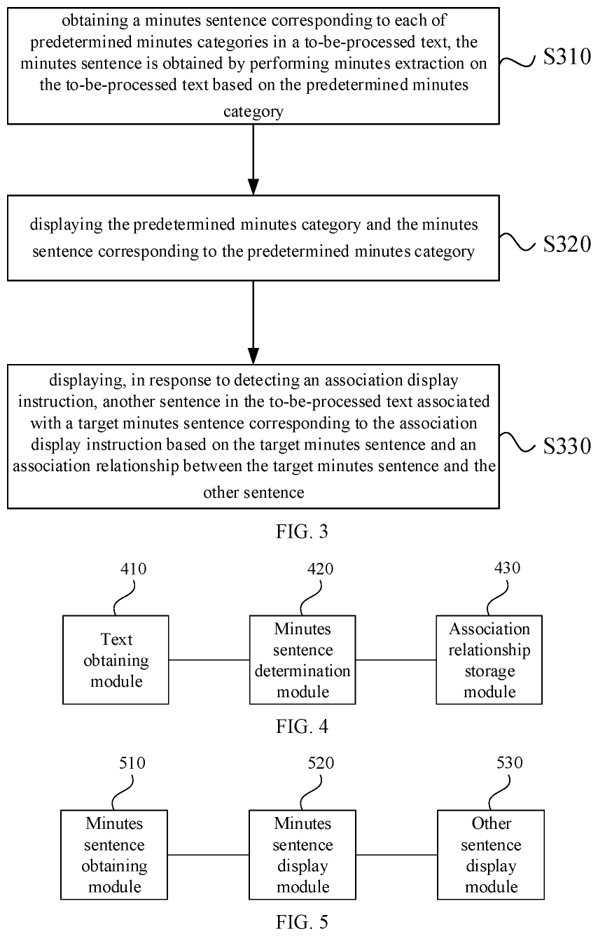

FIG. 3 is a flowchart of another minutes processing method according to an embodiment of the present disclosure. Referring to FIG. 3, the minutes processing method exemplary includes the following blocks.

S310, a minutes sentence corresponding to each of predetermined minutes categories in a to-be-processed text are obtained, the minutes sentences is obtained by performing minutes extraction on the to-be-processed text based on the predetermined minutes categories.

Before a conference minutes is displayed, each minutes sentence extracted according to the predetermined minutes categories is obtained first.

S320, the predetermined minutes category and the minutes sentence corresponding to the predetermined minutes category are displayed.

In order to display the conference minutes more clearly, the conference minutes needs to be displayed according to the predetermined minutes categories in the embodiment of the present disclosure. For example, each of the predetermined minutes categories is displayed, and a corresponding minutes sentence is displayed corresponding to each of the predetermined minutes categories. The display mode can be displaying in a region or a page different from a conference text display area in a form of a list or a segment and the like.

S330, in response to detecting an association display instruction, another sentence in the to-be-processed text associated with a target minutes sentence corresponding to the association display instruction is displayed based on the target minutes sentence and an association relationship between the target minutes sentence and the other sentence.

The associated display instruction refers to an instruction for starting the associated display of the other sentence.

If the associated display instruction is detected, a minutes sentence (i.e., a target minutes sentence) of the other sentence needing to display association is determined according to the associated display instruction. Then, the association relationship between the target minutes sentence and the other sentence is matched from the association relationship between each minutes sentence and the other sentence. Then, the other sentence associated with the target minutes sentence is determined according to the association relationship between the target minutes sentence and the other sentence. Finally, the determined another sentence is displayed, and its display mode should reflect the association relationship between the other sentence and the target minutes sentence. For example, in the same display area, display positions of upper and lower stages are used to respectively display the minutes sentence and the other sentence; or, they are displayed in different display areas respectively, but a visual association relationship and the like are established between the display area of the target minutes sentence and the display area of the other sentence. Therefore, such setting can display a conference detail sentence related to the minutes sentence more conveniently, and a user can conveniently and quickly position an interested conference content.

In some embodiments, the detecting the association display instruction includes: in response to detecting a sentence triggering operation on the target minutes sentence by a user, an instruction corresponding to the sentence triggering operation is determined as the association display instruction. In the embodiment, a control function is set for the minutes sentence displayed in a display interface, and it can be triggered by clicking or cursor residence (a cursor stays for certain duration to trigger), and a click event or a cursor residence trigger event is set as generation of the associated display instruction. Therefore, if a click triggering operation or a cursor residence triggering operation (namely, a sentence triggering operation) of the user on the target minutes sentence is detected, then an associated display instruction pointing to the target minutes sentence can be generated.

In some embodiments, the detecting the association display instruction includes: in response to detecting a control triggering operation on an association display control at the target minutes sentence by a user, an instruction corresponding to the control triggering operation is determined as the association display instruction. In the embodiment, a special associated display control is displayed on periphery of each minutes sentence, for example, a click control having characters such as “related sentences/associated sentences/associated contents” and the like, or a “+” control and the like are displayed. Moreover, the trigger event of the associated display control is set to be the generation of the associated display instruction. Therefore, if the click triggering operation (that is, a control triggering operation) of the user on the associated display control around the target minutes sentence is detected, then an associated display instruction pointing to the target minutes sentence can be generated.

In some embodiments, displaying the other sentence associated with the target minutes sentence includes at least one of items below: displaying the other sentence associated with the target minutes sentence at a predetermined position of the target minutes sentence; displaying the other sentence associated with the target minutes sentence in a pull-down box corresponding to the target minutes sentence; displaying the other sentence associated with the target minutes sentence in a new suspension window; and highlighting the other sentence associated with the target minutes sentence in the to-be-processed text.

In the embodiment, the mode of displaying the associated another sentence can be displaying the other sentence at the predetermined position of the target minutes sentence, for example, the other sentence associated with the target minutes sentence can be displayed below the target minutes sentence. The display mode may be, for example, displaying the predetermined minutes categories, the target minutes sentence and the other sentence in a form of a hierarchical directory.

Alternatively, the mode of displaying the associated another sentence may also be providing a pull-down box function for the target minutes sentence, so as to display the other sentence in the pull-down box.

Alternatively, the mode of displaying the associated another sentence can also be starting a new suspension window, there is a visual association relationship between the suspension window and the display position of the target minutes sentence, and the other sentence is displayed in the suspension window.

Alternatively, the mode of displaying the associated another sentence can also be highlighting the other sentence in the to-be-processed text. For example, in a conference scene, after a user clicks the target minutes sentence, the associated another sentence in the conference text is highlighted in a form such as high-brightness or different font/font size from the conference text. In this way, while seeing the other sentence, the user can see a context content thereof, so that the user can further conveniently find an interested content.

The minutes processing solution provided by the embodiment of the present disclosure, through obtaining the minutes sentence corresponding to each predetermined minutes categories in the to-be-processed text and displaying each predetermined minutes categories and each minutes sentence under the corresponding predetermined minutes categories; in response to the detection of the associated display instruction, based on the target minutes sentence corresponding to the associated display instruction and the association relationship between the target minutes sentence and the other sentence in the to-be-processed text, displays the other sentence associated with the target minutes sentence. A structured display of the multi-dimensional minutes and a special display of a detail sentence related to the minutes sentence are realized, so that the user can more conveniently position the interested text content.

FIG. 4 is a structural schematic diagram of a minutes processing apparatus according to an embodiment of the present disclosure, and the apparatus can be implemented by software and/or hardware and can be generally integrated in an electronic device, and a minutes can be generated by executing the minutes processing method. As shown in FIG. 4, the apparatus includes: a text acquisition module 410, a minutes sentence determination module 420, and an association relationship storage module 430.

The text acquisition module 410 is configured to obtain a to-be-processed text.

The minutes sentence determination module 420 is configured to perform minutes extraction on the to-be-processed text based on predetermined minutes categories to determine a minutes sentence corresponding to each of the predetermined minutes categories.

The association relationship storage module 430 is configured to determine another sentence associated with the minutes sentence from the to-be-processed text, and store an association relationship between the minutes sentence and the other sentence.

In some embodiments, the predetermined minutes categories include at least one of a task planning category, a text conclusion category, and a text topic category.

In some embodiments, the minutes sentence determination module 420 is further configured to: perform vectorization processing on each sentence in the to-be-processed text to determine a vectorization result for the sentence; and input the vectorization result into a pre-trained text recognition model, and determine the minutes sentence corresponding to each of the predetermined minutes categories according to a output result of the text recognition model. The text recognition model is configured to recognize whether the sentence belongs to one of the predetermined minutes categories.

In some embodiments, the text recognition model is a machine learning model, a training sample of the machine learning model being a plurality of sentences having category indications. Each of the category indications indicates a predetermined minutes categories to which a corresponding sentence belongs.

In some embodiments, the minutes sentence determination module 420 is further configured to perform text matching on the to-be-processed text based on category indications corresponding to the predetermined minutes categories; and determine the minutes sentence belonging to the predetermined minutes categories according to a result of the text matching.

In some embodiments, the association relationship storage module 430 is further configured to: determine the other sentence corresponding to the minutes sentence based on a position of each sentence in the to-be-processed text and a position of the minutes sentence in the to-be-processed text; and/or determine the other sentence corresponding to the minutes sentence based on a vectorization result of each sentence in the to-be-processed text and a vectorization result of the minutes sentence in the to-be-processed text.

According to the minutes processing apparatus provided by the embodiment of the present disclosure, the minutes extraction can be performed on the to-be-processed text according to the predetermined minutes categories, and the minutes sentence corresponding to each predetermined minutes categories are respectively obtained, which achieves extraction of the text from multiple dimensions and improves compatibility of the minutes to various text forms and an information content of the minutes. Moreover, the other sentences remaining in the to-be-processed text can be associated with the minutes sentence, so that other text contents associated with the minutes sentence are quickly obtained from the minutes sentence, and the query efficiency of the to-be-processed text is improved.

FIG. 5 is a structural schematic diagram of another minutes processing apparatus according to an embodiment of the present disclosure, and the apparatus may be implemented by software and/or hardware and may be generally integrated in an electronic device, and it may display a minutes by executing the minutes processing method. As shown in FIG. 5, the apparatus includes: a minutes sentence acquisition module 510, a minutes sentence display module 520 and an other sentence display module 530.

The minutes sentence acquisition module 510 is configured to obtain a minutes sentence corresponding to each of predetermined minutes categories in a to-be-processed text. The minutes sentence is obtained by performing minutes extraction on the to-be-processed text based on the predetermined minutes categories

The minutes sentence display module 520 is configured to display the predetermined minutes category and the minutes sentence corresponding to the predetermined minutes category.

The other sentence display module 530 is configured to display, in response to detecting an association display instruction, another sentence in the to-be-processed text associated with a target minutes sentence corresponding to the association display instruction based on the target minutes sentence and an association relationship between the target minutes sentence and the other sentence.

In some embodiments, the other sentence display module 530 is further configured to: in response to detecting a sentence triggering operation on the target minutes sentence by a user, an instruction corresponding to the sentence triggering operation is determined as the association display instruction.

In some embodiments, the other sentence display module 530 is further configured to: in response to detecting a control triggering operation on an association display control at the target minutes sentence by a user, an instruction corresponding to the control triggering operation is determined as the association display instruction.

In some embodiments, the other sentence display module 530 is further configured to display the other sentence associated with the target minutes sentence in at least one of following manners.

The other sentence associated with the target minutes sentence at a predetermined position of the target minutes sentence is displayed.

The other sentence associated with the target minutes sentence in a pull-down box corresponding to the target minutes sentence is displayed.

The other sentence associated with the target minutes sentence in a new suspension window is displayed.

The other sentence associated with the target minutes sentence in the to-be-processed text is prominently displayed.

According to the minutes processing apparatus provided by the embodiment of the present disclosure, the structured display of the multi-dimensional minutes and the special display of the detail sentence related to the minutes sentence are realized, so that the user can more conveniently position the interested text content.

The minutes processing apparatus provided by the embodiment of the present disclosure can execute the corresponding minutes processing method provided by any embodiment of the present disclosure and has a function module and a beneficial effect corresponding to the execution method.

It is worth noting that in the embodiment of the minutes processing apparatus, all the modules included are divided according to a function logic but are not limited to the division, as long as corresponding functions can be realized; in addition, specific names of the various function modules are only used for facilitating mutual distinguishing and not used for limiting the protection range of the present disclosure.

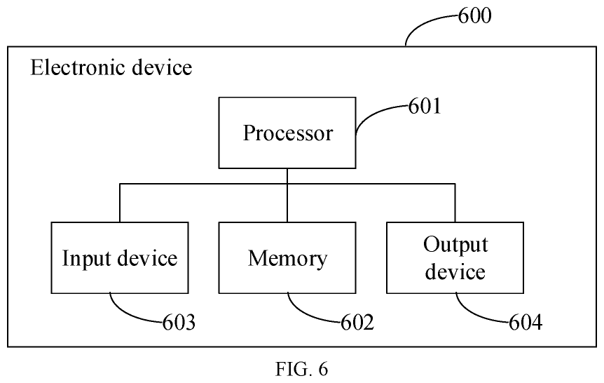

FIG. 6 is a structural schematic diagram of an electronic device according to an embodiment of the present disclosure. As shown in FIG. 6, the electronic device 600 includes one or more processors 601 and a memory 602.

The processor 601 may be a central processing unit (CPU) or other forms of processing units having data processing capabilities and/or instruction execution capabilities, and it may control other components in the electronic device 600 to perform desired functions.

The memory 602 may include one or more computer program products, and the computer program product may include various forms of computer-readable storage media, such as volatile memory and/or non-volatile memory. The volatile memory may include, for example, a random-access memory (RAM) and/or a cache, and the like. The non-volatile memory may include, for example, a read-only memory (ROM), a hard disk, a flash memory, and the like. One or more computer program instructions may be stored on the computer readable storage medium, and the processor 601 may run the program instruction, to implement the minutes processing method of the embodiments of the present disclosure described above and/or other desired functions. Various contents such as minutes sentences, another sentences, association relationships and the like can also be stored in the computer readable storage medium.

In one example, the electronic device 600 may also include: an input device 603 and an output device 604 that are interconnected by a bus system and/or other forms of connection mechanisms (not shown).

In addition, the input device 603 may further include, for example, a keyboard, a mouse, and the like.

The output device 604 can output various information to outside, including a to-be-processed text, a determined minutes sentence, associated another sentences and the like. The output device 604 may include, for example, a display, a speaker, a printer, and a communications network and a remote output device connected thereto, etc.

Of course, for simplicity, only some of the components related to the present disclosure in the electronic device 600 are shown in FIG. 6, and components such as buses, input/output interfaces, and the like are omitted. In addition, according to specific application conditions, the electronic device 600 may further include any other suitable components.

Besides the method and the apparatus described above, the embodiment of the present disclosure can also be a computer program product which includes a computer program instruction, and when the computer program instruction is operated by the processor, the processor is caused to execute the minutes processing method provided by the embodiment of the present disclosure.

The computer program product may be written in one or any combination of more programming languages to write program code for performing operations of the embodiments of the present disclosure, and the programming languages include object-oriented programming languages, such as Java, C++, and conventional procedural programming languages, such as “C” languages or similar programming languages. The program code may be executed entirely on the user's computer, executed partly on the user's computer, executed as a stand-alone software package, executed partly on the user's computer and partly on a remote computer, or executed entirely on the remote computer or server.

In addition, the embodiment of the present disclosure can also be a computer readable storage medium, a computer program instruction is stored on the computer readable storage medium, and when the computer program instruction is operated by the processor, the processor is caused to execute the minutes processing method provided by the embodiment of the present disclosure.

The computer-readable storage medium may employ one or any combination of more readable media. The readable medium may be a readable signal medium or a readable storage medium. The readable storage medium may include, for example, but not limited to, an electrical, magnetic, optical, electromagnetic, infrared, or semiconductor system, device, or component, or any combination thereof. More exemplary examples (non-exhaustive lists) of the readable storage media include: electrically connected by one or more wires, portable computer disk, hard disk, random access memory (RAM), read-only memory (ROM), erasable programmable read-only memory (EPROM or flash memory), optical fiber, portable compact disk read-only memory (CD-ROM), optical storage component, magnetic storage component, or any suitable combination thereof.

It should be noted that, in this description, the terms “including”, “comprising”, or any other variant thereof are intended to cover a non-exclusive inclusion, such that a process, method, article, or device including a series of elements includes not only those elements, but also includes other elements not explicitly listed, or includes elements inherent to such a process, method, article, or device. In the absence of more restrictions, elements limited by a sentence “includes one . . . ” don't exclude that other identical elements are also present in the processes, methods, articles, or devices that include the elements.

The above are merely exemplary embodiments of the present disclosure, so that those skilled in the art can understand or implement the present disclosure. Various modifications to these embodiments will be apparent to those skilled in the art, and general principles defined herein may be implemented in other embodiments without departing from the spirit or scope of the present disclosure. Thus, the present disclosure will not be limited to these embodiments described herein, but be accorded the widest scope consistent with the principles and novel features disclosed herein.

1. A minutes processing method, comprising:
obtaining a to-be-processed text;
performing minutes extraction on the to-be-processed text based on predetermined minutes categories to determine a minutes sentence belonging to each of the predetermined minutes categories; and
determining another sentence associated with the minutes sentence from the to-be-processed text, and storing an association relationship between the minutes sentence and the other sentence.

2. The method according to claim 1, wherein the predetermined minutes categories comprise at least one of a task planning category, a text conclusion category, and a text topic category.

3. The method according to claim 1, wherein the performing the minutes extraction on the to-be-processed text based on predetermined minutes categories to determine the minutes sentence belonging to each of the predetermined minutes categories comprises:
performing vectorization processing on each sentence in the to-be-processed text to determine a vectorization result for the sentence; and
inputting the vectorization result into a pre-trained text recognition model, and determining the minutes sentence corresponding to each of the predetermined minutes categories according to a output result of the text recognition model, the text recognition model being configured to recognize whether the sentence belongs to one of the predetermined minutes categories.

4. The method according to claim 3, wherein the text recognition model is a machine learning model, a training sample of the machine learning model being a plurality of sentences having category indications, and each of the category indications indicating a predetermined minutes categories to which a corresponding sentence belongs.

5. The method according to claim 1, wherein the performing the minutes extraction on the to-be-processed text based on the predetermined minutes categories, and determining the minutes sentence corresponding to each of the predetermined minutes categories comprises:
performing text matching on the to-be-processed text based on category indications corresponding to the predetermined minutes categories; and determining the minutes sentence belonging to the predetermined minutes categories according to a result of the text matching.

6. The method according to claim 1, wherein the determining the other sentence associated with the minutes sentence from the to-be-processed text comprises:
determining the other sentence corresponding to the minutes sentence based on a position of each sentence in the to-be-processed text and a position of the minutes sentence in the to-be-processed text; and/or
determining the other sentence corresponding to the minutes sentence based on a vectorization result of each sentence in the to-be-processed text and a vectorization result of the minutes sentence in the to-be-processed text.

7. A minutes processing method, comprising:
obtaining a minutes sentence corresponding to each of predetermined minutes categories in a to-be-processed text, the minutes sentence being obtained by performing minutes extraction on the to-be-processed text based on the predetermined minutes category;
displaying the predetermined minutes category and the minutes sentence corresponding to the predetermined minutes category; and
displaying, in response to detecting an association display instruction, another sentence in the to-be-processed text associated with a target minutes sentence corresponding to the association display instruction based on the target minutes sentence and an association relationship between the target minutes sentence and the other sentence.

8. The method according to claim 7, wherein the detecting the association display instruction comprises:
determining, in response to detecting a sentence triggering operation on the target minutes sentence, an instruction corresponding to the sentence triggering operation as the association display instruction.

9. The method according to claim 7, wherein the detecting the association display instruction comprises:
determining, in response to detecting a control triggering operation on an association display control at the target minutes sentence, an instruction corresponding to the control triggering operation as the association display instruction.

10. The method according to claim 7, wherein the displaying the other sentence associated with the target minutes sentence comprises:
displaying the other sentence associated with the target minutes sentence at a predetermined position of the target minutes sentence; and/or
displaying the other sentence associated with the target minutes sentence in a pull-down box corresponding to the target minutes sentence; and/or
displaying the other sentence associated with the target minutes sentence in a new suspension window; and/or
prominently displaying the other sentence associated with the target minutes sentence in the to-be-processed text.

11. (canceled)

12. (canceled)

13. An electronic device, comprising:
a processor; and
a memory having an executable instruction of the processor stored thereon,
wherein the executable instruction, when executed by the processor, causes the processor to:
obtain a to-be-processed text;
perform minutes extraction on the to-be-processed text based on predetermined minutes categories to determine a minutes sentence belonging to each of the predetermined minutes categories; and
determine another sentence associated with the minutes sentence from the to-be-processed text, and store an association relationship between the minutes sentence and the other sentence.

14. (canceled)

15. The electronic device according to claim 13, wherein the predetermined minutes categories comprise at least one of a task planning category, a text conclusion category, and a text topic category.

16. The electronic device according to claim 13, wherein the executable instruction, when executed by the processor, further causes the processor to:
perform vectorization processing on each sentence in the to-be-processed text to determine a vectorization result for the sentence; and
input the vectorization result into a pre-trained text recognition model, and determine the minutes sentence corresponding to each of the predetermined minutes categories according to a output result of the text recognition model, the text recognition model being configured to recognize whether the sentence belongs to one of the predetermined minutes categories.

17. The electronic device according to claim 16, wherein the text recognition model is a machine learning model, a training sample of the machine learning model being a plurality of sentences having category indications, and each of the category indications indicating a predetermined minutes categories to which a corresponding sentence belongs.

18. The electronic device according to claim 13, wherein the executable instruction, when executed by the processor, further causes the processor to:
perform text matching on the to-be-processed text based on category indications corresponding to the predetermined minutes categories; and determine the minutes sentence belonging to the predetermined minutes categories according to a result of the text matching.

19. The electronic device according to claim 13, wherein the executable instruction, when executed by the processor, further causes the processor to:
determine the other sentence corresponding to the minutes sentence based on a position of each sentence in the to-be-processed text and a position of the minutes sentence in the to-be-processed text; and/or
determine the other sentence corresponding to the minutes sentence based on a vectorization result of each sentence in the to-be-processed text and a vectorization result of the minutes sentence in the to-be-processed text.

20. An electronic device, comprising:
a processor; and
a memory having an executable instruction of the processor stored thereon,
wherein the executable instruction, when executed by the processor, causing the processor to:
obtain a minutes sentence corresponding to each predetermined minutes categories in a to-be-processed text, the minutes sentence being obtained by performing minutes extraction on the to-be-processed text based on the predetermined minutes categories;
display the predetermined minutes category and the minutes sentence corresponding to the predetermined minutes category; and
display, in response to detecting an association display instruction, another sentence in the to-be-processed text associated with a target minutes sentence corresponding to the association display instruction based on the target minutes sentence and an association relationship between the target minutes sentence and the other sentence.

21. The electronic device according to claim 20, wherein the executable instruction, when executed by the processor, further causes the processor to:
determine in response to detecting a sentence triggering operation on the target minutes sentence, an instruction corresponding to the sentence triggering operation as the association display instruction.

22. A computer readable storage medium, having a computer program stored thereon, the computer program being configured to implement the minutes processing method according to claim 7.

23. A computer readable storage medium, having a computer program stored thereon, the computer program being configured to implement the minutes processing method according to claim 7.
